(19) United States
(12) Patent Application Publication
(10) Pub. No.: US 2022/0070783 A1
(43) Pub. Date: Mar. 3, 2022

(54) NR PAGING EARLY INDICATOR

(71) Applicant: MEDIATEK INC., Hsinchu City (TW)

(72) Inventors: Chi-Hsuan HSIEH, Hsinchu City (TW); Jianwei ZHANG, Beijing (CN); Nien-En WU, Hsinchu City (TW); Wei-De WU, Hsinchu City (TW)

(21) Appl. No.: 17/420,178

(22) PCT Filed: Apr. 22, 2020
(86) PCT No.: PCT/CN2020/086098

§ 371 Date: Jul. 1, 2021

Related U.S. Application Data
(60) Provisional application No. 62/838,389, filed on Apr. 25, 2019.

(51) Int. Cl. H04W 52/02; H04W 76/28; H04W 68/02; H04W 56/00

(52) U.S. Cl. CPC H04W 52/0235; H04W 76/28; H04W 76/27; H04W 56/001; H04W 68/02

(57) ABSTRACT

Aspects of the disclosure provide a method and an apparatus for monitoring a paging occasion (PO). For example, the apparatus can include receiving circuitry and processing circuitry. The receiving circuitry can be configured to receive an SS block burst set including a sequence of SS blocks that are each associated with a paging early indicator indicating whether a paging massage is presented in at least one PO that comes later than the SS block burst set. The processing circuitry can be configured to monitor the at least one PO for the paging message when the paging early indicator indicates that the paging message is presented in the at least one PO, and enter a sleep state without monitoring the at least one PO when the paging early indicator indicates that the paging message is not presented in the at least one PO.

### INCORPORATION BY REFERENCE

This present disclosure claims the benefit of U.S. Provisional Application No. 62/838,389, “NR Paging Early Indicator” filed on Apr. 25, 2019, which is incorporated herein by reference in its entirety.

### TECHNICAL FIELD

The present disclosure relates to wireless communications, and, more particularly, to a method and an apparatus for monitoring a paging occasion (PO).

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

High frequency bands (e.g., above 6 GHz) are used in 5^{th} generation (5G) system to increase system capacity. Beamforming schemes can be employed to focus transmitted and/or received signals in a desired direction to compensate for undesirable path loss of high frequency signals. For example, a base station (BS) may perform a beam sweeping to cover its serving area.

Paging can be used for system information updating or network-initiated connection setup when user equipment (UE) is in radio resource control (RRC) idle mode or RRC inactive mode. For example, the UE can sleep with no receiver processing most of the time, and briefly wake up according to a predefined cycle to monitor paging information from the network.

### SUMMARY

Aspects of the disclosure provide a method for user equipment (UE) to monitor a paging occasion (PO). The method can include receiving from a base station (BS) a synchronization signal (SS) block burst set including a sequence of SS blocks that are each associated with a paging early indicator indicating whether a paging message is presented in at least one PO that comes later than the SS block burst set. The method can further include monitoring the at least one PO that comes later than the SS block burst set for the paging message when the paging early indicator indicates that the paging message is presented in the at least one PO that comes later than the SS block burst set, and entering a sleep state without monitoring the at least one PO that comes later than the SS block burst set when the paging early indicator indicates that the paging message is not presented in the at least one PO that comes later than the SS block burst set.

According to some embodiments of the disclosure, the paging early indicator can be time-division multiplexed (TDMed) with the SS block. For example, the paging early indicator is transmitted at a symbol before the SS block. For another example, the paging early indicator is transmitted at a symbol after the SS block. According to some other embodiments of the disclosure, the paging early indicator can be frequency-division multiplexed (FDMed) with the SS block. For example, the paging early indicator is FDMed with a primary synchronization signal (PSS) of the SS block. For another example, the paging early indicator is transmitted at same symbols as the SS block.

Additionally, the paging early indicator can be a sequence of bits that are scrambled with at least one of a UE ID, a paging group ID, and a paging-radio network temporary identifier (P-RNSI). Further, the paging early indicator can be received during a first discontinuous reception (DRX) cycle, and the at least one PO that comes later than the SS block burst is monitored during a second DRX cycle. For example, the second DRX cycle is identical to the first DRX cycle. For another example, the second DRX cycle follows the first DRX cycle.

Aspects of the disclosure provide an apparatus, which can include receiving circuitry and processing circuitry. The receiving circuitry can be configured to receive an SS block burst set including a sequence of SS blocks that are each associated with a paging early indicator indicating whether a paging massage is presented in at least one PO that comes later than the SS block burst set. The processing circuitry can be configured to monitor the at least one PO that comes later than the SS block burst set for the paging message when the paging early indicator indicates that the paging message is presented in the at least one PO that comes later than the SS block burst set, and enter a sleep state without monitoring the at least one PO that comes later than the SS block burst set when the paging early indicator indicates that the paging message is not presented in the at least one PO that comes later than the SS block burst set.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary beam-based wireless communication system according to some embodiments of the disclosure;

FIG. 2 shows an exemplary synchronization signal (SS) block according to some embodiments of the disclosure;

FIG. 3 shows an exemplary SS block transmission configuration according to some embodiments of the disclosure;

FIG. 4 shows exemplary frame structures corresponding to different subcarrier spacings according to some embodiments of the disclosure;

FIG. 5 shows a table including exemplary SS block configurations according to some embodiments of the disclosure;

FIGS. 6-8 illustrate SS block configurations of cases A-E in FIG. 5;

FIG. 9 shows an exemplary paging configuration according to some embodiments of the disclosure;

FIG. 10 is a flow chart of an exemplary method for monitoring a paging occasion according to some embodiments of the disclosure;

FIGS. 11 and 12 show exemplary SS blocks time-domain multiplexed with paging early indicators according to some embodiments of the disclosure;

FIGS. 13 and 14 show exemplary SS blocks frequency-domain multiplexed with paging early indicators according to some embodiments of the disclosure; and

FIG. 15 is a functional block diagram of an exemplary apparatus for monitoring a paging occasion according to some embodiments of the disclosure.

### DETAILED DESCRIPTION OF EMBODIMENTS

When UE is operating in radio resource control (RRC) idle mode, no RRC context is established, and no data transfer may take place as the UE sleeps most of the time to reduce battery consumption. In the downlink, the UE in RRC idle mode periodically wakes up to monitor paging messages sent from a base station (BS). When the UE wakes up to monitor paging in each discontinuous reception (DRX) cycle, timing and frequency synchronization between the UE and the BS may be lost. In order to obtain reliable paging detection, the UE performs timing/frequency tracking to regain timing/frequency synchronization. For example, based on some reference signals (e.g., synchronization signal (SS) blocks) received from the BS and known to the UE, the UE may estimate a timing/frequency mismatch, and accordingly adjust related circuits to compensate the estimated timing/frequency mismatch.

After the timing/frequency tracking, the UE may turn into a sleeping state, and wake up again before the paging detection operation. However, the BS does not send paging messages in every DRX cycle. Therefore, it is advisable for the UE not to wake up or to still stay in the sleep state after the timing/frequency tracking when no paging message present in a paging occasion (PO). An paging early indicator that indicates whether the BS will send a paging message is used according to the disclosure. For example, the paging early indicator can be time-domain multiplexed with the SS blocks. For another embodiment, the paging early indicator can be frequency-domain multiplexed with the SS blocks. Therefore, when performing the timing/frequency tracking, the UE can have the knowledge about whether a paging message is presented in a PO during the following paging detection operation. When no paging message is presented in the PO, the UE can still stay in the sleep state, thus reducing power consumption.

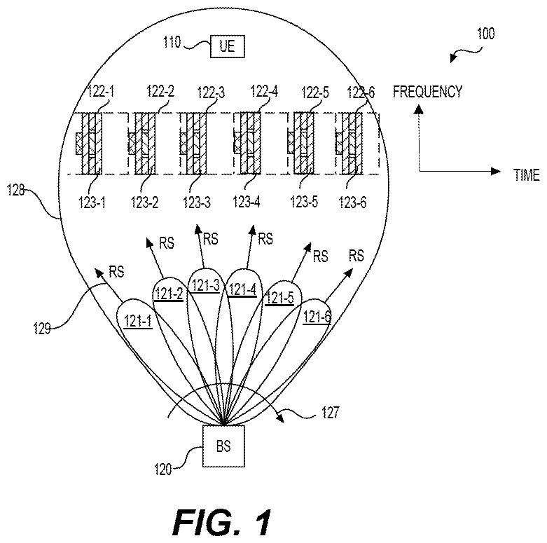

FIG. 1 shows an exemplary beam-based wireless communication system 100 according to some embodiments of the disclosure. The wireless communication system 100 can include user equipment (UE) 110 and a base station (BS) 120. The wireless communication system 100 can employ 5th generation (5G) wireless communication technologies developed by the 3rd Generation Partnership Project (3GPP). Further, the wireless communication system 100 can employ beam-based technologies other than technologies developed by 3GPP.

Millimeter Wave (mm-Wave) frequency bands and beamforming technologies can be employed in the wireless communication system 100. Accordingly, the UE 110 and the BS 120 can perform beamformed transmission or reception. In beamformed transmission, wireless signal energy can be focused on a specific direction to cover a target serving region. As a result, an increased antenna transmission (Tx) gain can be achieved in contrast to omnidirectional antenna transmission. Similarly, in beamformed reception, wireless signal energy received from a specific direction can be combined to obtain a higher antenna reception (Rx) gain in contrast to omnidirectional antenna reception. The increased Tx or Rx gain can compensate path loss or penetration loss in mm-Wave signal transmission.

The BS 120 can be a base station implementing a gNB node as specified in 5G new radio (NR) air interface standards developed by 3GPP. The BS 120 can be configured to control one or more antenna arrays to form directional Tx or Rx beams for transmitting or receiving wireless signals. In some embodiments, different sets of antenna arrays are distributed at different locations to cover different serving areas. Each set of antenna arrays can be referred to as a transmission reception point (TRP).

In the example shown in FIG. 1, the BS 120 can control a TRP to form Tx beams 121-1 to 121-6 to cover a cell 128. The beams 121-1 to 121-6 can be generated towards different directions. The beams 121-1 to 121-6 can be generated simultaneously or in different time intervals in different examples. In an embodiment, the BS 120 is configured to perform a beam sweeping 127 to transmit downlink L1/L2 control channel and/or data channel signals. During the beam sweeping 127, Tx beams 121-1 to 121-6 towards different directions can be successively formed in a time division multiplex (TDM) manner, such as time intervals 122-1 to 122-6, which include synchronization signal (SS) blocks 123-1 to 123-6, respectively, to cover the cell 128. During each of the time intervals 122-1 to 122-6 for transmission of one of the beams 121-1 to 121-6, a set of L1/L2 control channel data and/or data channel data can be transmitted with the respective Tx beam. The beam sweeping 127 can be performed repeatedly with a certain periodicity. In alternative embodiments, the beams 121-1 to 121-6 may be generated in a way other than performing a beam sweeping. For example, multiple beams towards different directions may be generated at a same time. In other embodiments, different from the example shown in FIG. 1, where the beams 121-1 to 121-6 are generated vertically, the BS 120 can generate beams towards different horizontal or vertical directions. In an embodiment, the maximum number of beams generated from a TRP can be 64.

Each beam 121-1 to 121-6 can be associated with various reference signals (RSs) 129, such as channel-state information reference signal (CSI-RS), demodulation reference signal (DMRS), or the synchronization signals (SSs) 123-1 to 123-6 (e.g., primary synchronization signal (PSS), and secondary synchronization signal (SSS)). Those RSs can serve for different purposes depending on related configurations and different scenarios. For example, some RSs can be used as beam identification RSs for purpose of identifying a beam, and/or beam quality measurement RSs for monitoring beam qualities. Each beam 121-1 to 121-6, when transmitted at different occasions, may carry different signals, such as different L1/L2 data or control channels, or different RSs.

In an embodiment, the beams 121-1 to 121-6 of the cell 128 can be associated with synchronization signal blocks (SS blocks) (also referred to as SS/PBCH blocks) 123-1 to 123-6. For example, each SS block 123-1 to 123-6 can include SSs (e.g., PSS, SSS) and a physical broadcast channel (PBCH) carried on several consecutive orthogonal frequency division multiplexing (OFDM) symbols in an OFDM based system. For example, the BS 120 may periodically transmit a sequence of SS blocks (referred to as an SS block burst set). The SS block burst set may be transmitted by performing a beam sweeping. For example, each SS block 123-1 to 123-6 of the SS block burst set is transmitted using one of the beams 121-1 to 121-6. The sequence of SS blocks 123-1 to 123-6 may each carry an SS block index indicating a timing or location of each SS block among the sequence of SS blocks 123-1 to 123-6.

The UE 110 can be a mobile phone, a laptop computer, a vehicle carried mobile communication device, a utility meter fixed at a certain location, and the like. Similarly, the UE 110 can employ one or more antenna arrays to generate directional Tx or Rx beams for transmitting or receiving wireless signals. While only one UE 110 is shown in FIG. 1, a plurality of UEs can be distributed within or outside of the cell 128, and served by the BS 120 or other BSs not shown in FIG. 1. In the example shown in FIG. 1, the UE 110 is within the coverage of the cell 128.

The UE 110 can operate in radio resource control (RRC) connected mode, RRC inactive mode, or RRC idle mode. For example, when the UE 110 is operating in RRC connected mode, an RRC context is established and known to both the UE 110 and the BS 120. The RRC context includes parameters necessary for communication between the UE 110 and the BS 120. An identity of the UE 110, such as a cell radio network temporary identified (C-RNTI), can be used for signaling between the UE 110 and the BS 120.

When the UE 110 is operating in RRC idle mode, there is no RRC context established. The UE 110 does not belong to a specific cell. For example, no data transfer may take place. The UE 110 sleeps most of the time in order to save power, and wakes up according to a paging cycle to monitor if a paging message is coming from the network side of the wireless communication system 100. Triggered by a paging message (e.g., system information updating, or a connection establishment request), the UE 110 may transfer from RRC idle mode to RRC connected mode. For example, the UE 110 can establish uplink synchronization, and an RRC context can be established in both the UE 110 and the BS 120.

When the UE 110 is operating in RRC inactive mode, RRC context is maintained by the UE 110 and the BS 120. However, similar to RRC idle mode, the UE 110 may be configured with discontinuous reception (DRX). For example, the UE 110 sleeps most of the time in order to save power, and wake up according to a paging cycle to monitor paging transmission. When triggered, the UE 110 can promptly transition from RRC inactive mode to RRC connected mode to transmit or receive data with fewer signaling operations than a transition from RRC idle mode to RRC connected mode.

The wireless communication system 100 uses a paging mechanism to convey paging information to the UE 110 in some embodiments. The paging information can be originated from the BS 120 or a core network element of the wireless communication system 100. For example, the core network element can transmit a paging message to the UE 110 in RRC idle mode or RRC inactive mode to initiate a connection setup in response to an incoming call. The BS 120 may transmit a paging message to inform the UE 110 (either in RRC idle mode, RRC inactive mode, or RRC connected mode) about a change in system information, an emergency notification, an earthquake or tsunami warning notification, and the like.

In some embodiments, the paging message is carried in an L1/L2 downlink data channel, such as a physical downlink shared channel (PDSCH). Corresponding to the PDSCH carrying the paging message, downlink control information (DCI) containing scheduling information of the PDSCH can be carried in an L1/L2 downlink control channel, such as a physical downlink control channel (PDCCH). Such type of DCI for indicating a paging transmission can be referred to as a paging DCI, and the corresponding PDCCH can be referred to as a paging PDCCH. In addition, a group identity, such as a paging radio network temporary identifier (P-RNTI), can be attached to the paging DCI. For example, a cyclic redundancy check (CRC) of the paging DCI may be scrambled with the P-RNTI. The P-RNTI can be preconfigured to one or a group of UEs and used for identifying a DCI as a paging DCI.

A paging cycle may be configured by the BS 120 for a group of UEs including the UE 110, and the group can be associated with a group identity P-RNTI. The paging cycle can be the same as or larger than the SS block burst cycle. A time window, referred to as paging occasion window (PO window), for performing a potential paging transmission can be defined for each paging cycle. During a PO window, a same set of paging DCIs may be transmitted multiple times via a beam sweeping. Each transmission of the same set of paging DCIs may correspond to one of the sequence of beams 121-1 to 121-6 generated during the beam sweeping. In other words, during the PO window, the beam sweeping is performed, and the same set of paging DCIs is repeatedly transmitted on each of the sequence of beams 121-1 to 121-6 to cover different directions of the cell 128. A set of OFDM symbols (e.g., one or multiple symbols) carrying the same set of paging DCIs (e.g., one or more paging DCIs) is transmitted on each beam 121-1 to 121-6. Transmission or duration of such a set of OFDM symbols can be referred to as a paging occasion (PO).

As described below, depending on related contexts, a PO can also refer to a PO window that includes multiple transmissions of paging DCIs, or a slot that corresponds to a transmission time interval (TTI) and includes the set of OFDM symbols carrying paging DCIs.

The UE 110 can be configured with the paging cycle described above for paging monitoring operations when in RRC idle or inactive mode in some embodiments. For example, the UE 110 in RRC idle mode or RRC inactive mode can wake up during time intervals predefined by a DRX configuration, and monitor whether a paging DCI is coming from the BS 120. The PO window including a sequence of POs as described above can also be configured to the UE 110. The UE can accordingly perform paging detection at the POs within the PO window. For example, the UE 110 may perform a blind PDCCH decoding to search for a paging DCI associated with a P-RNTI assigned to the UE 110 at a PO. If such a paging DCI is found, the UE 110 may locate the PDSCH according to the scheduling information contained in the paging DCI.

In some embodiments, before the PDCCH decoding, the UE 110 may first perform timing and frequency synchronization with the BS 120 based on SSs of an SS block burst set. For example, in a DRX configuration, a DRX cycle can be an interval corresponding to 32, 64, 128, or 256 frames. Accordingly, the RRX cycle can be 320 ms, 640 ms, 1280 ms, 2560 ms, and the like. When the UE 110 wakes up to monitor paging messages in each DRX cycle, timing and frequency synchronization between the UE 110 and the BS 120 may be lost. For example, due to frequency drift of a crystal oscillator at the UE within a DRX cycle, especially in case of a large DRX cycle (e.g., 2560 ms), carrier frequency offset (CFO) and sample clock frequency offset (SCO) between a receiver of the UE 110 and a transmitter of the BS 120 may arise. As a result, orthogonal property of OFDM symbols may be lost.

In order to obtain reliable paging detection, the UE 110 performs timing/frequency tracking to regain timing/frequency synchronization, or some other procedures, such as automatic gain control (AGC). For example, based on some reference signals (e.g., SS blocks, tracking reference signals (TRS)) received from the BS 120 and known to the UE 110, the UE 110 may estimate a timing/frequency mismatch (e.g., CFO, SCO), and accordingly adjust related circuits to compensate the estimated timing/frequency mismatch. After the timing/frequency tracking is completed, the UE 110 proceeds to perform the paging detection.

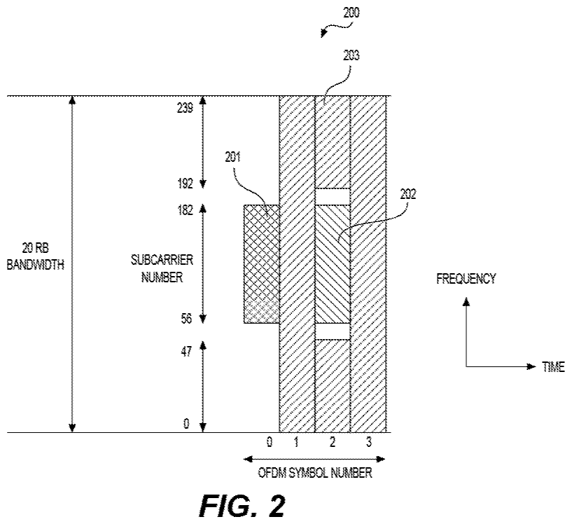

FIG. 2 shows an exemplary an SS block 200, e.g., the SS block 123-1 in FIG. 1, used in the wireless communication system 100 according to some embodiments of the disclosure. The SS block 200 can include a PSS 201, an SSS 202, and a PBCH 203 (represented with shaded areas designated with numbers of 201, 202, and 203, respectively). Those signals can be carried in REs on a time-frequency resource grid as shown in FIG. 2. In addition, the SS block 200 can carry DMRSs (not shown) in a subset of REs in the shaded area 203. The REs carrying DMRSs are not used for carrying PBCH signals in one example.

In an embodiment, the SS block 200 can be distributed over four OFDM symbols in time domain and occupy a twenty resource block (RB) bandwidth in frequency domain. As shown in FIG. 2, the four OFDM symbols are numbered from 0 to 3, while the 20 RB bandwidth includes 240 subcarriers numbered from 0 to 239. Specifically, the PSS 201 can occupy REs at symbol 0 and subcarriers 56-182. The SSS 202 can occupy REs at symbol 2 and subcarriers 56-182. The PBCH 203 can be located at symbols 1-3 occupying twenty RBs at symbols 1 and 3, and eight RBs (96 subcarriers) at symbol 2.

In an embodiment, the SS block 200 is configured to carry bits of an SS block index by using the DMRSs and the PBCH 203. In another embodiment, by decoding the PSS 201 and the SSS 202, a physical layer cell identification (ID) can be determined. The cell ID indicates which cell the SS block 200 is associated with.

SS blocks in various examples may have structures different from the example shown in FIG. 2. OFDM symbols carrying SSs and OFDM symbols carrying PBCH may be arranged in different order in time domain. Bandwidth of an SS block may be different from that of the example shown in FIG. 2. REs assigned for SSs or PBCH may by more or less than that in the example shown in FIG. 2.

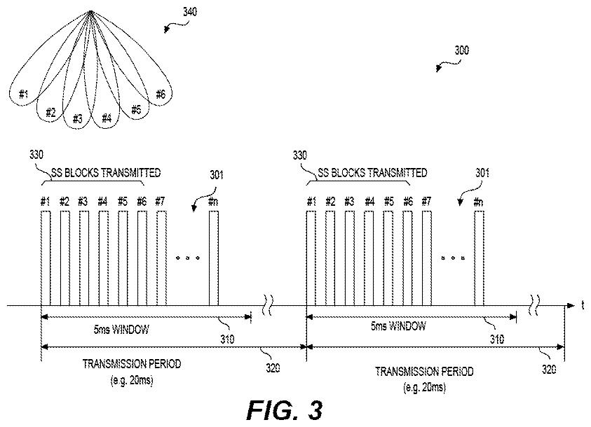

FIG. 3 shows an example SS block transmission configuration 300 according to some embodiments of the disclosure. According to the configuration 300, a sequence 301 of SS blocks, referred to as SS block burst set 301, can be transmitted with a transmission period 320 (e.g., 5, 10, 20, 40, 80, or 160 ms) in a sequence of radio frames. The SS block burst set 301 can be confined within a half frame transmission window 310 (e.g., 5 ms). Each configured SS block can have an SS block index (e.g., from #1 to #n). The SS blocks of the SS block set 301 are configured as candidate SS blocks, but may not be used for actual transmissions of SS blocks. For example, a cell 340 employs six beams from #1 to #6 to cover a serving area and transmits SS blocks based on the configuration 300. Accordingly, only a subset 330 of the SS block set 301 is transmitted. For example, the transmitted SS blocks 330 may include the first six candidate SS blocks of the SS block set 301 each corresponding to one of the beams #1-#6. Resources corresponding to other candidate SS blocks from #7 to #n can be used for transmission of data other than SS blocks.

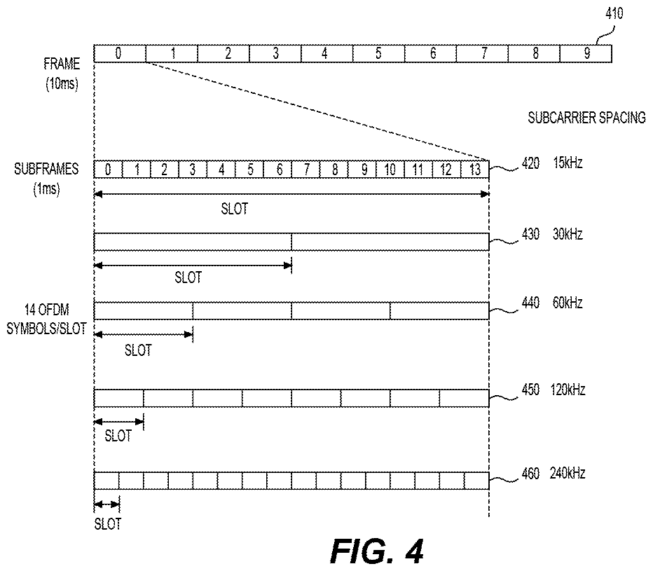

FIG. 4 shows an exemplary frame structures used in the wireless communication system 100 corresponding to different subcarrier spacings according to some embodiments of the disclosure. A radio frame 410 can last for 10 ms and include ten subframes that each last for 1 ms. Corresponding to different numerologies and respective subcarrier spacings, a subframe may include different number of slots. For example, for a subcarrier spacing of 15 kHz, 30 kHz, 60 kHz, 120 kHz, or 240 kHz, a respective subframe 420-460 can include 1, 2, 4, 8, or 16 slots, respectively. Each slot may include 14 OFDM symbols in one example. In alterative examples, different frame structures may be employed.

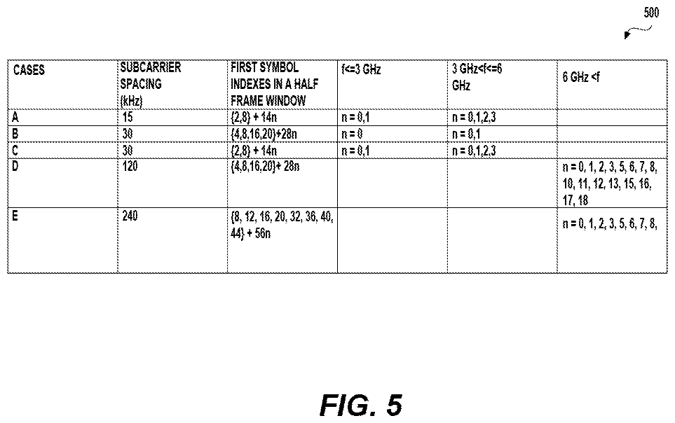

FIG. 5 shows a table 500 including exemplary SS block configurations within a 5 ms half frame time window according to an embodiment of the disclosure. The table 500 shows five cases A-E of SS block configurations in five rows of the table 500. The five cases A-E correspond to different subcarrier spacing configurations of a cell. For each case, indexes of first symbols in each SS block within a half frame (e.g., 5 ms) are specified.

For example, in case A with 15 kHz subcarrier spacing, the first symbols of the candidate SS blocks have symbol indexes of {2, 8}+14n. For carrier frequencies smaller than or equal to 3 GHz, n=0, 1, corresponding to a total number of L=4 SS blocks. Accordingly, the four candidate SS blocks can have SS block indexes in an ascending order in time from 0 to 3. For carrier frequencies larger than 3 GHz and smaller than or equal to 6 GHz, n=0, 1, 2, 3, corresponding to a total number of L=8 candidate SS blocks. Accordingly, the eight candidate SS blocks can have SS block indexes in an ascending order in time from 0 to 7.

For another example, in case D with 120 kHz subcarrier spacing, the first symbols of the candidate SS blocks have symbol indexes of {4, 8, 16, 20}+28n. For carrier frequencies larger than 6 GHz, n=0, 1, 2, 3, 5, 6, 7, 8, 10, 11, 12, 13, 15, 16, 17, 18, corresponding to a total number of L=64 candidate SS blocks. Accordingly, the 64 candidate SS blocks can have SS block indexes in an ascending order in time from 0 to 63.

It is noted that SS block configurations different from that shown in FIG. 5 may be used in other examples.

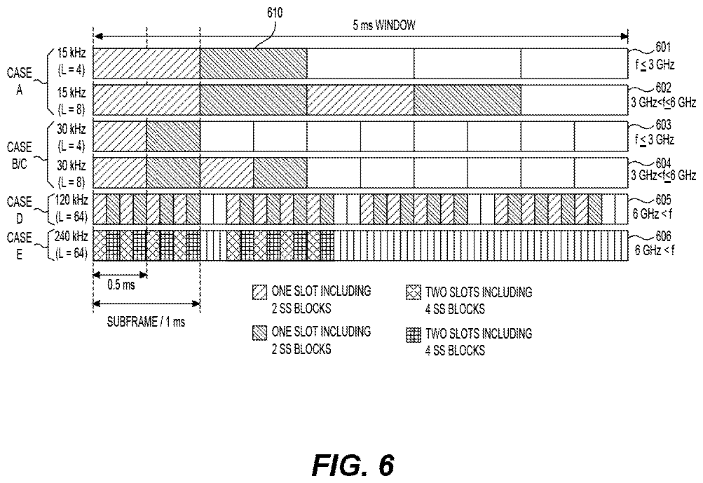

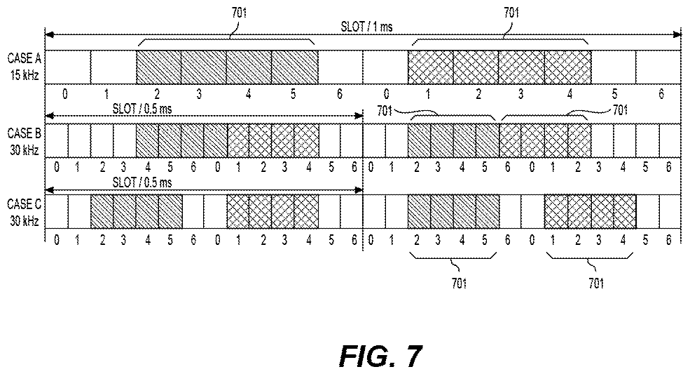

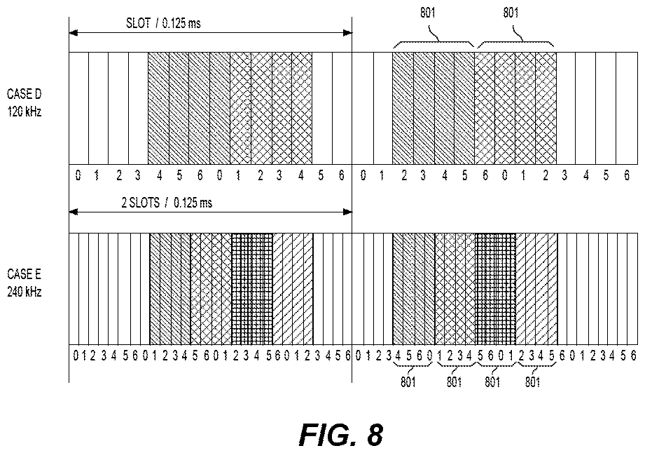

FIGS. 6-8 illustrate the SS block configurations of cases A-E in FIG. 5. Specifically, FIG. 6 shows six SS block configurations 601-606 corresponding to different combinations of subcarrier spacings and frequency bands. In each configuration 601-606, slots containing SS blocks within a half frame window are shown with shaded rectangles 610. FIGS. 7 and 8 show zoomed-in views of how SS blocks 701 or 801 are distributed over sequences of symbols in time domain.

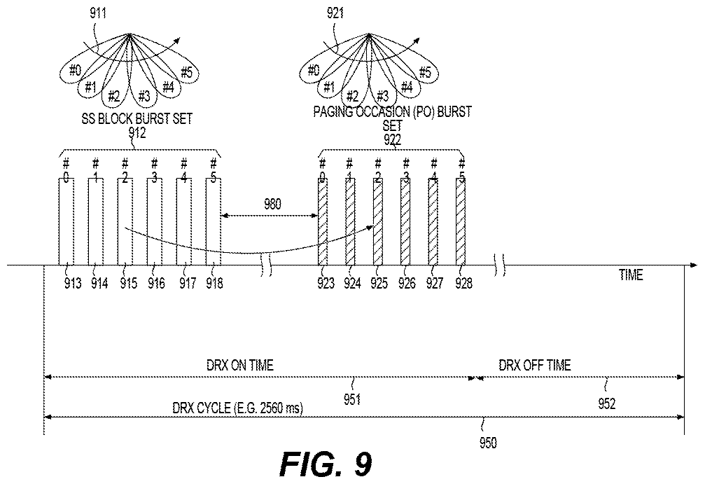

FIG. 9 shows an exemplary paging configuration 900 according to some embodiments of the disclosure. Based on the paging configuration 900, the UE 110 can periodically perform timing/frequency tracking and paging detection process (also referred to as a paging reception process) to monitor if there is paging information transmitted from the BS 120 and intended for the UE 110. The SS block burst set 912 includes SS blocks 913-918 transmitted on the beams #0-#5, respectively. The SS block burst set 921 includes SS blocks 923-928 transmitted on the beams #0-#5, respectively.

During an exemplary timing/frequency tracking and paging detection process, based on the above described paging configuration 900, the UE 110 first performs timing/frequency tracking. For example, a DRX cycle 950 is configured by the network side of the system 100. The DRX cycle 950 has duration of 2560 ms, and includes a DRX ON time 951 and a DRX OFF time 952. The UE 110 in RRC idle or RRC inactive mode sleeps during the DRX OFF time 952 and wakes up to monitor paging during the DRX ON time 951.

During the DRX ON time 951, the UE 110 first performs the timing/frequency tracking. For example, the UE 110 may listen to signals within a preconfigured bandwidth and search for SS block transmissions. The UE 110 may receive the SS blocks 913-918 of the SS block burst set 912, and measure a quality (e.g., reference signal received power (RSRP)) for each SS block 913-918 using SSs (e.g., SSSs) carried in each SS block. In an embodiment, based on the measurement, the UE 110 may select a best one (or best ones) of the SS blocks 913-918. For example, the SS block 915 having the beam index #2 is selected. The UE 110 accordingly performs the timing/frequency tracking using SSs (e.g., SSSs) of the selected SS block 915. The UE 110 may turn into a sleeping state during an interval 980 after the timing/frequency tracking and before the paging detection operation.

After the sleep state, the UE 110 wakes up again and performs paging detection at a PO determined according to the selected SS block 915. For example, the PO 925 that is quasi-co-located (QCLed) with the selected SS block 915 can be determined for the paging detection. Accordingly, based on the beam index #2 of the selected SS block 915, the UE 110 may find the PO 925 among the sequence of POs 923-928, and subsequently decode respective paging PDCCHs carried in the PO 925.

On occasion, no paging message is presented in the PO 925. However, the UE 110 will not have any prior knowledge about this. Therefore, the UE 110 still needs to wake up again from the sleep state 980 and decode the paging PDCCHs carried in the PO 925. In a low signal-to-noise ratio (SNR) scenario, the UE 110 may have to wake up for a longer period of time and decode more than on one PO, which undesirably consumes more power.

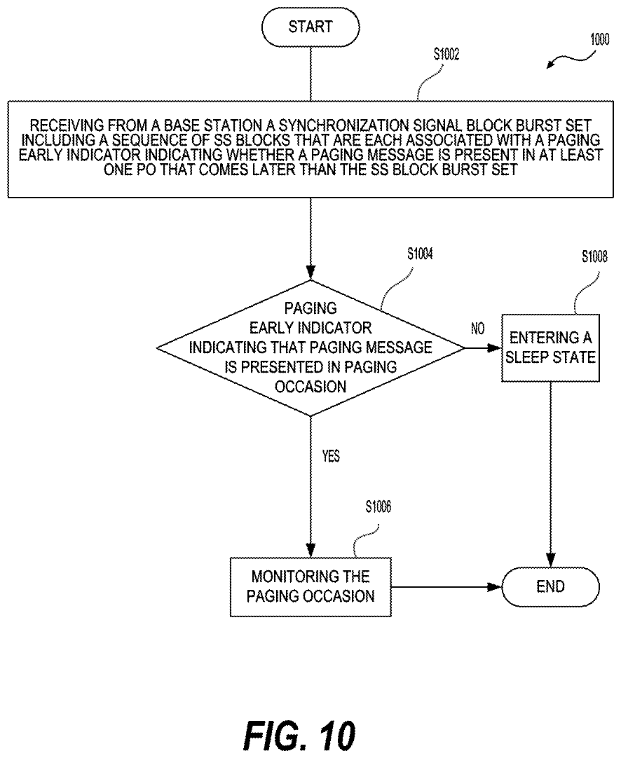

FIG. 10 is a flow chart of an exemplary method 1000 for monitoring a paging occasion (PO) according to some embodiments of the disclosure. The method 1000 is applicable to the wireless communication system 100. A paging early indicator that indicates whether a paging message is presented in a PO is used according to some embodiments of the disclosure. Through the paging early indicator, the UE 110 knows whether a paging message is presented in a PO, and determines whether to still stay in the sleep state 980 or wake up in the following paging detection operation.

According to some embodiments of the disclosure, the method 1000 can include receiving from a BS a SS block burst set including a sequence of SS blocks that are each associated with a paging early indicator indicating whether a paging message is presented in at least one PO that comes later than the SS block burst set, at step S1002. For example, the UE 110 receives from the BS 120 the SS block burst set 912, which includes a sequence of SS blocks 913-918, each of which is associated with a paging early indicator. The paging early indicator indicates whether a paging message is presented in the POs 923-928, which come later than the SS block burst set 912.

At step S1004, whether the paging early indicator indicating that the paging message is presented in the PO is determined. When the paging early indicator indicates that the paging message is presented in the at least one PO that comes later than the SS block burst set, the at least one PO that comes later than the SS block burst set is monitored for the paging message, at step S1006. For example, when the paging early indicator indicates that the paging message is presented in the PO 925, the UE 110 wakes up and monitors the PO 925 for the paging message during the paging detection operation. On the contrary, when the paging early indicator indicates that the paging message is not present in the at least one PO that comes later than the SS block burst set, the sleep state is entered, at step S1008, without monitoring the at least one PO that comes later than the SS block burst set. For example, when the paging early indicator indicates that the paging message is not present in the PO 925, the UE 110 enters the sleep state (or does not wake up from the sleep state during the interval 980). As the UE 110 is in the sleep state, or does not wake up, when the paging message is not present in the PO 925, power is saved.

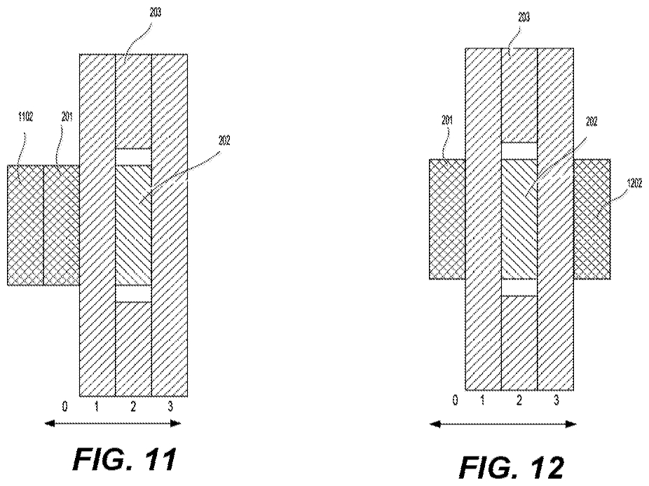

In some embodiments of the disclosure, the paging early indicator can be time-division multiplexed (TDMed) with the SS block. For example, a paging early indicator 1102 is transmitted at a symbol before the PSS 201, the SSS 202 and the PBCH 203 (collectedly referred to as the SS block 200), as shown in FIG. 11. As shown in FIG. 12, another paging early indicator 1202 is transmitted at a symbol after the PSS 201, the SSS 202 and the PBCH 203.

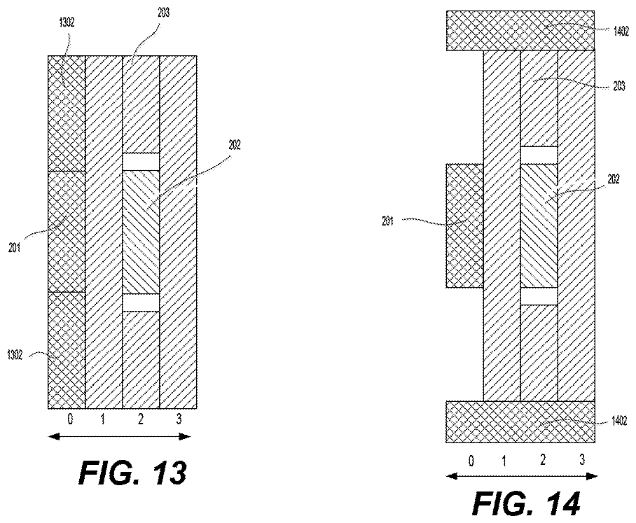

In another embodiment, the paging early indicator can be frequency-division multiplexed (FDMed) with the SS block. For example, a paging early indicator 1302 is FDMed with the PSS 201 of the SS block 200, as shown in FIG. 13. For another embodiment, another paging early indicator 1402 is transmitted at same symbols as the SS block 200, as shown in FIG. 14.

Refer to FIGS. 9 and 11-14, which show that the SS blocks 913-918 of the SS block burst 912 and their associated TDMed and FDMed paging early indicators 1102, 1202, 1302 and 1402 are received during the DRX cycle 950, and the POs 923-928, which come later than the SS block burst 912, are monitored also during the DRX cycle 950. According to some other embodiments of the disclosure, the SS blocks and their associated paging early indicators and the POs that are indicated by the paging early indicators as to whether they have paging messages can be received during two different DRX cycles. For example, the SS blocks 913-918 and their associated paging early indicators 1102, 1202, 1302 and 1402 are received during the DRX cycle 950, and the paging early indicators 1102, 1202, 1302 and 1402 indicate whether POs during another DRX cycle that follows the DRX cycle 950 have paging messages and need to be monitored. Therefore, the UE 110 can have the knowledge about whether it will receive a paging message during the another DRX cycle, and select simplified timing/frequency tracking and automatic gain control schemes that are to be performed during the another DRX cycle.

According to some embodiments of the disclosure, the paging early indicator is a sequence of bits that are scrambled with at least one of a UE ID, a paging group ID, and a paging-radio network temporary identifier (P-RNSI).

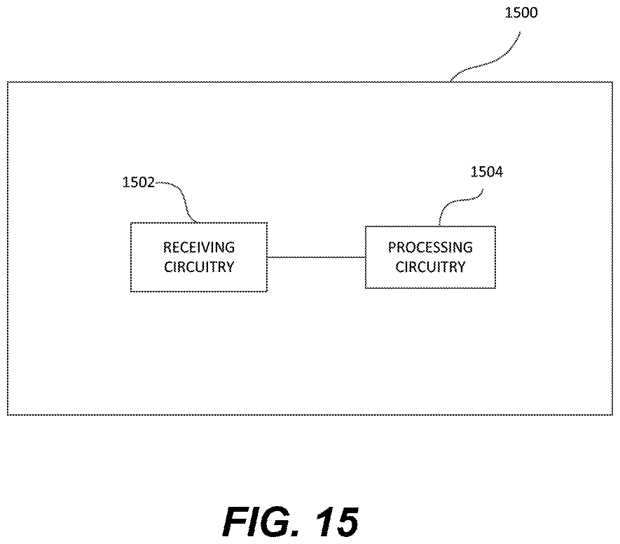

FIG. 15 shows an exemplary apparatus 1500 according to some embodiments of the disclosure. The apparatus 1500 can be configured to perform various functions in accordance with one or more embodiments or examples described herein. Thus, the apparatus 1500 can provide means for implementation of techniques, processes, functions, components, systems described herein. For example, the apparatus 1500 can be used to implement functions of the UE 110 in various embodiments and examples described herein. The apparatus 1500 can be a general purpose computer in some embodiments, and can be a device including specially designed circuits to implement various functions, components, or processes described herein in other embodiments. The apparatus 1500 can include receiving circuitry 1502 and processing circuitry 1504.

According to an embodiment, the receiving circuitry 1502 can be configured to receive an SS block burst set including a sequence of SS blocks that are each associated with a paging early indicator indicating whether a paging massage is presented in at least one PO that comes later than the SS block burst set. According to another embodiment of the disclosure, the processing circuitry 1504 can be configured to monitor the at least one PO that comes later than the SS block burst set for the paging message when the paging early indicator indicates that the paging message is presented in the at least one PO that comes later than the SS block burst set, and enter a sleep state without monitoring the at least one PO that comes later than the SS block burst set when the paging early indicator indicates that the paging message is not present in the at least one PO that comes later than the SS block burst set.

In various embodiments according to the disclosure, the receiving circuitry 1502 and the processing circuitry 1504 can include circuitry configured to perform the functions and processes described herein in combination with software or without software. In various examples, the processing circuitry can be a digital signal processor (DSP), an application specific integrated circuit (ASIC), programmable logic devices (PLDs), field programmable gate arrays (FPGAs), digitally enhanced circuits, or comparable device or a combination thereof.

In some other embodiments according to the disclosure, the processing circuitry 1504 can be a central processing unit (CPU) configured to execute program instructions to perform various functions and processes described herein.

The apparatus 1500 can optionally include other components, such as input and output devices, additional or signal processing circuitry, and the like. Accordingly, the apparatus 1500 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

1. A method for user equipment (UE) to monitor a paging occasion (PO), comprising:
receiving from a base station (BS) a synchronization signal (SS) block burst set including a sequence of SS blocks that are each associated with a paging early indicator indicating whether a paging message is presented in at least one PO that comes later than the SS block burst set;
monitoring the at least one PO that comes later than the SS block burst set for the paging message when the paging early indicator indicates that the paging message is presented in the at least one PO that comes later than the SS block burst set; and
entering a sleep state without monitoring the at least one PO that comes later than the SS block burst set when the paging early indicator indicates that the paging message is not presented in the at least one PO that comes later than the SS block burst set.

2. The method of claim 1, wherein the paging early indicator is time-division multiplexed (TDMed) with the SS block.

3. The method of claim 2, wherein the paging early indicator is transmitted at a symbol before the SS block.

4. The method of claim 2, wherein the paging early indicator is transmitted at a symbol after the SS block.

5. The method of claim 1, wherein the paging early indicator is frequency-division multiplexed (FDMed) with the SS block.

6. The method of claim 5, wherein the paging early indicator is FDMed with a primary synchronization signal (PSS) of the SS block.

7. The method of claim 5, wherein the paging early indicator is transmitted at same symbols as the SS block.

8. The method of claim 1, wherein the paging early indicator is a sequence of bits that are scrambled with at least one of a UE ID, a paging group ID, and a paging-radio network temporary identifier (P-RNSI).

9. The method of claim 1, wherein the paging early indicator is received during a first discontinuous reception (DRX) cycle, and the at least one PO that comes later than the SS block burst is monitored during a second DRX cycle that is identical to the first DRX cycle.

10. The method of claim 1, wherein the paging early indicator is received during a first DRX cycle, and the at least one PO that comes later than the SS block burst is monitored during a second DRX cycle that follows the first DRX cycle.

11. An apparatus, comprising:
receiving circuitry configured to receive an SS block burst set including a sequence of SS blocks that are each associated with a paging early indicator indicating whether a paging massage is presented in at least one PO that comes later than the SS block burst set; and
processing circuitry configured to monitor the at least one PO that comes later than the SS block burst set for the paging message when the paging early indicator indicates that the paging message is presented in the at least one PO that comes later than the SS block burst set, and enter a sleep state without monitoring the at least one PO that comes later than the SS block burst set when the paging early indicator indicates that the paging message is not presented in the at least one PO that comes later than the SS block burst set.

12. The apparatus of claim 11, wherein the paging early indicator is TDMed with the SS block.

13. The apparatus of claim 12, wherein the paging early indicator is transmitted at a symbol before the SS block.

14. The apparatus of claim 12, wherein the paging early indicator is transmitted at a symbol after the SS block.

15. The apparatus of claim 11, wherein the paging early indicator is FDMed with the SS block.

16. The apparatus of claim 15, wherein the paging early indicator is FDMed with a PSS of the SS block.

17. The apparatus of claim 15, wherein the paging early indicator is transmitted at same symbols as the SS block.

18. The apparatus of claim 11, wherein the paging early indicator is a sequence of bits that are scrambled with at least one of a UE ID, a paging group ID and a paging-radio network temporary identifier (P-RNSI).

19. The apparatus of claim 11, wherein the paging early indicator is received during a first DRX cycle, and the at least one PO that comes later than the SS block burst is monitored during a second DRX cycle that is identical to the first DRX cycle.

20. The apparatus of claim 11, wherein the first paging early indicator is received during a first DRX cycle, and the at least one PO that comes later than the SS block burst is monitored during a second DRX cycle that follows the first DRX cycle.
